(19) United States
(12) Patent Application Publication
(10) Pub. No.: US 2024/0251477 A1
(43) Pub. Date: Jul. 25, 2024

(54) MULTICAST AND BROADCAST SERVICE TRANSMISSION FOR A REMOTE WTRU VIA A RELAY WTRU

(71) Applicant: InterDigital Patent Holdings, Inc., Wilmington, DE (US)

(72) Inventors: Saad Ahmad, Montreal (CA); Xiaoyan Shi, Lake Oswego (CA); Michelle Perras, Montreal (CA); Anuj Sethi, Ottawa (CA); Samir Ferdi, Kirkland (CA)

(73) Assignee: InterDigital Patent Holdings, Inc., Wilmington, DE (US)

(21) Appl. No.: 18/289,853

(22) PCT Filed: May 6, 2022
(86) PCT No.: PCT/US2022/028100

§ 371 Date: Nov. 7, 2023

Related U.S. Application Data
(60) Provisional application No. 63/185,884, filed on May 7, 2021.

(51) Int. Cl. H04W 76/40; H04W 88/04

(52) U.S. Cl. CPC H04W 76/40; H04W 88/04

(57) ABSTRACT

A WTRU (e.g., relay WTRU) may be configured to send a first message. The first message may indicate that the relay WTRU supports a multicast-broadcast service (MBS). The relay WTRU may receive a second message from a WTRU (e.g., a remote WTRU). The second message may indicate an MBS service announcement (SA) request, a remote WTRU identity (ID), and a description of an MBS service. The relay WTRU may determine one or more service parameters. The one or more service parameters may be requested by the MBS SA request. The one or more service parameters may be associated with the MBS service. The WTRU may send a third message to the remote WTRU. The third message may indicate the one or more service parameters.

### CROSS-REFERENCE TO RELATED APPLICATIONS

This application claims the benefit of Provisional U.S. Patent Application No. 63/185,884, filed May 7, 2021, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for (e.g., enabling) multicast and broadcast services (MBS) transmission for a (e.g., 5G) remote wireless transmit receive unit (WTRU) via a relay WTRU.

A WTRU (e.g., relay WTRU) may be configured to send a first message. The first message may indicate that the relay WTRU supports a multicast-broadcast service (MBS). The relay WTRU may receive a second message from a WTRU (e.g., a remote WTRU). The second message may indicate an MBS service announcement (SA) request, a remote WTRU identity (ID), and/or a description of an MBS service. The relay WTRU may determine one or more service parameters. The one or more service parameters may be requested by the MBS SA request. The one or more service parameters may be associated with the MBS service. In examples, the one or more service parameters may be determined by using SA information associated with a previous request. The WTRU may send a third message to the remote WTRU. The third message may indicate the one or more service parameters. In examples, the third message may (e.g., may further) indicate an MBS SA response.

In examples, the one or more service parameters may include at least one of: a data network name (DNN), an MBS service session ID, a target service WTRU group ID, an internet protocol (IP) multicast address, or a temporary mobile group identity (TMGI). In examples, the one or more service parameters may be determined by sending a fourth message to a network. The fourth message may indicate a remote WTRU ID and a description of the MBS service. The relay WTRU may receive a fifth message (e.g., a SA message) from the network. The fifth message may indicate SA information. The SA information may be associated with the remote WTRU ID and with the description of the MBS service. The SA information may indicate a content provider. The content provider may be associated with the MBS service. The one or more service parameters may be determined using the SA information.

A WTRU (e.g., a remote WTRU) may be configured to receive a first message. The first message may indicate that a WTRU (e.g., a relay WTRU) supports a MBS. The remote WTRU may send a second message to the relay WTRU. The second message may indicate a remote WTRU ID and a description of an MBS service to be provided by a network. In examples, the second message may (e.g., may further) indicate an MBS SA request. The remote WTRU may receive a third message from the relay WTRU. The third message may indicate one or more service parameters associated with the MBS service. In examples, the third message may (e.g., may further) indicate an MBS SA response. The one or more service parameters may include at least one of: a DNN, an MBS service session ID, a target service WTRU group ID, an IP multicast address, or a TMGI.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example architecture of a ProSe WTRU-to-network relay.

FIG. 3 illustrates an example of a flow diagram for a WTRU to receive multicast traffic.

FIG. 4 illustrates an example of phases of broadcast data provisioning.

FIGS. 5A and 5B illustrate an example procedure for a remote WTRU to receive an MBS service announcement (SA).

FIG. 6 illustrates an example procedure for a remote WTRU to receive an MBS service that may be associated with a relay service code (RSC).

FIG. 7 illustrates an example procedure for a remote WTRU to receive an MBS service that may be associated with a destination layer 2 (L2) ID.

### DETAILED DESCRIPTION

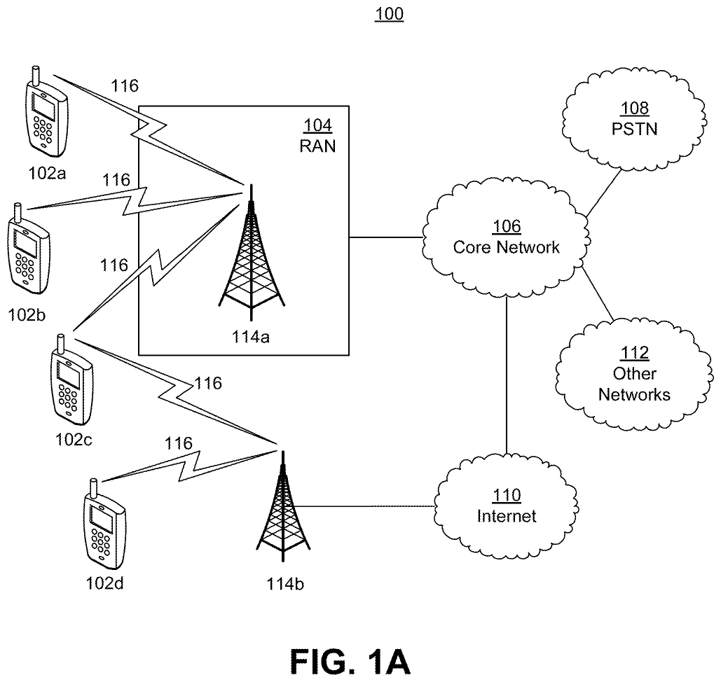

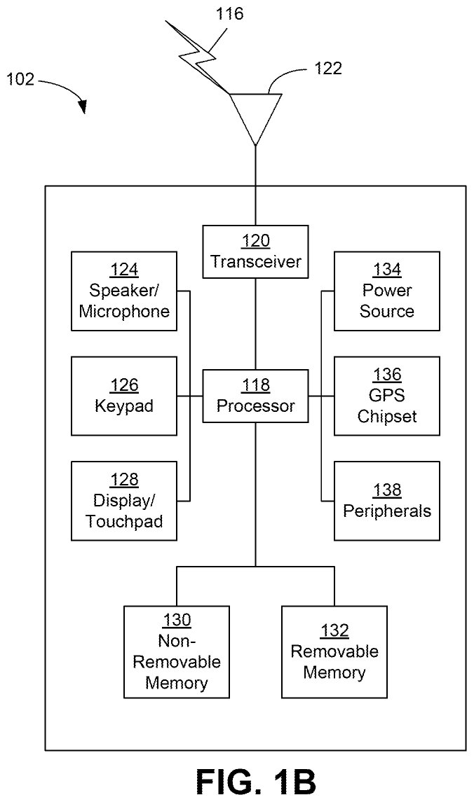

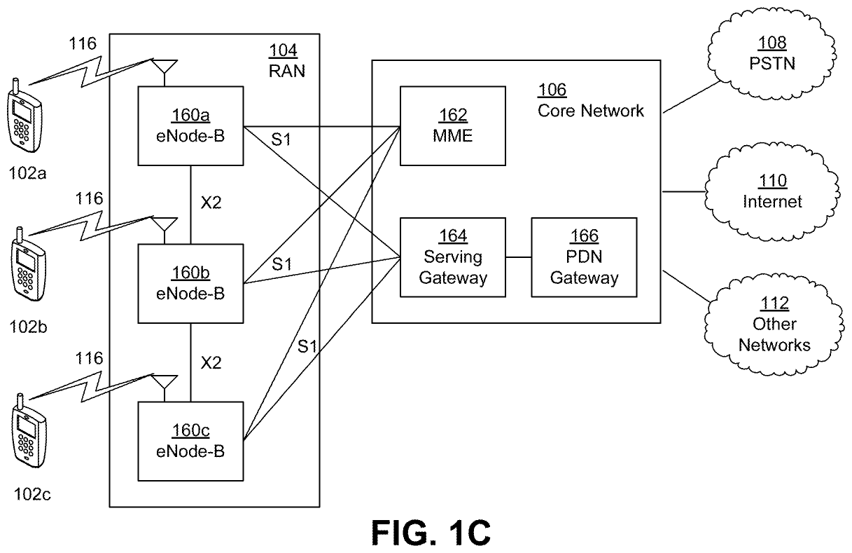

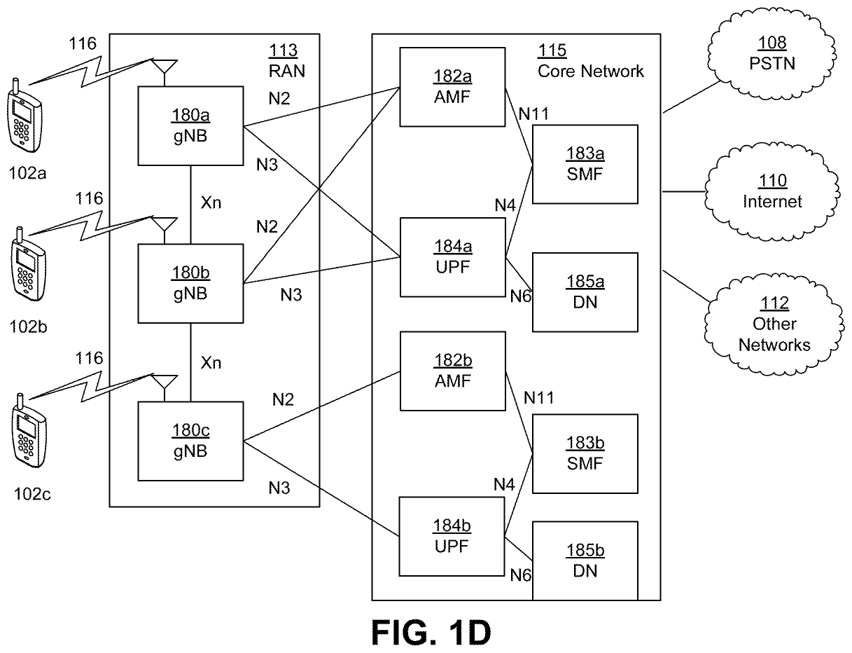

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for (e.g., enabling) multicast and broadcast service (MBS) transmission for a (e.g., 5G) remote wireless transmit receive unit (WTRU) via a relay WTRU.

A WTRU (e.g., relay WTRU) may be configured to send a first message. The first message may indicate that the relay WTRU supports a MBS. The relay WTRU may receive a second message from a WTRU (e.g., a remote WTRU). The second message may indicate an MBS service announcement (SA) request, a remote WTRU identity (ID), and a description of an MBS service. The relay WTRU may determine one or more service parameters. The one or more service parameters may be requested by the MBS SA request. The one or more service parameters may be associated with the MBS service. In examples, the one or more service parameters may be determined by using SA information associated with a previous request. The WTRU may send a third message to the remote WTRU. The third message may indicate the one or more service parameters. In examples, the third message may (e.g., may further) indicate an MBS SA response.

In examples, the one or more service parameters may include at least one of: a data network name (DNN), an MBS service session ID, a target service WTRU group ID, an internet protocol (IP) multicast address, or a temporary mobile group identity (TMGI). In examples, the one or more service parameters may be determined by sending a fourth message to a network. The fourth message may indicate a remote WTRU ID and a description of the MBS service. The relay WTRU may receive a fifth message (e.g., a SA message) from the network. The fifth message may indicate SA information. The SA information may be associated with the remote WTRU ID and with the description of the MBS service. The SA information may indicate a content provider. The content provider may be associated with the MBS service. The one or more service parameters may be determined using the SA information.

A WTRU (e.g., a remote WTRU) may be configured to receive a first message. The first message may indicate that a WTRU (e.g., a relay WTRU) supports a MBS. The remote WTRU may send a second message to the relay WTRU. The second message may indicate a remote WTRU ID and a description of an MBS service to be provided by a network. In examples, the second message may (e.g., may further) indicate an MBS SA request. The remote WTRU may receive a third message from the relay WTRU. The third message may indicate one or more service parameters associated with the MBS service. In examples, the third message may (e.g., may further) indicate an MBS SA response. The one or more service parameters may include at least one of: a DNN, an MBS service session ID, a target service WTRU group ID, an IP multicast address, or a TMGI.

A WTRU (e.g., a relay WTRU) may receive SA information. The WTRU may broadcast support for MBS based on the received SA information. The WTRU may receive an MBS SA request from the remote WTRU. The MBS SA request may include, a remote WTRU identifier (ID) and/or a universal service descriptor (USD). The WTRU may check if there is existing SA information corresponding to the received USD. The WTRU may send a message (e.g., a NAS message) with the remote WTRU ID and USD to an access and mobility management function (AMF). The WTRU may receive the SA information (e.g., based on the process) from the content provider application function (AF). The WTRU may respond with the MBS SA response, which may include the SA parameters.

A remote WTRU and/or a relay WTRU may be provisioned or configured with an association between a relay service code (RSC) and an MBS session ID (e.g., a TMGI). The application layer in a remote WTRU may trigger a remote WTRU to receive MBS traffic for a (e.g., specific) packet data unit (PDU) session ID. The remote WTRU may retrieve the corresponding RSC for the PDU session ID and discover the relay WTRU that supports the RSC. The remote WTRU may establish a PC5 connection with the relay WTRU for the RSC. The relay WTRU may join the MBS session based on the association between RSC and MBS session ID. The relay WTRU may deliver received MBS traffic to the remote WTRU.

A remote WTRU and a relay WTRU may be provisioned or configured with an association between a destination layer 2 (L2) ID for MBS and an MBS session ID. A remote WTRU may retrieve the destination L2 ID for MBS if the application layer in a remote WTRU triggers the remote WTRU to receive the MBS traffic of a (e.g., specific) PDU session ID. The remote WTRU may monitor the destination L2 ID for MBS to receive the MBS traffic.

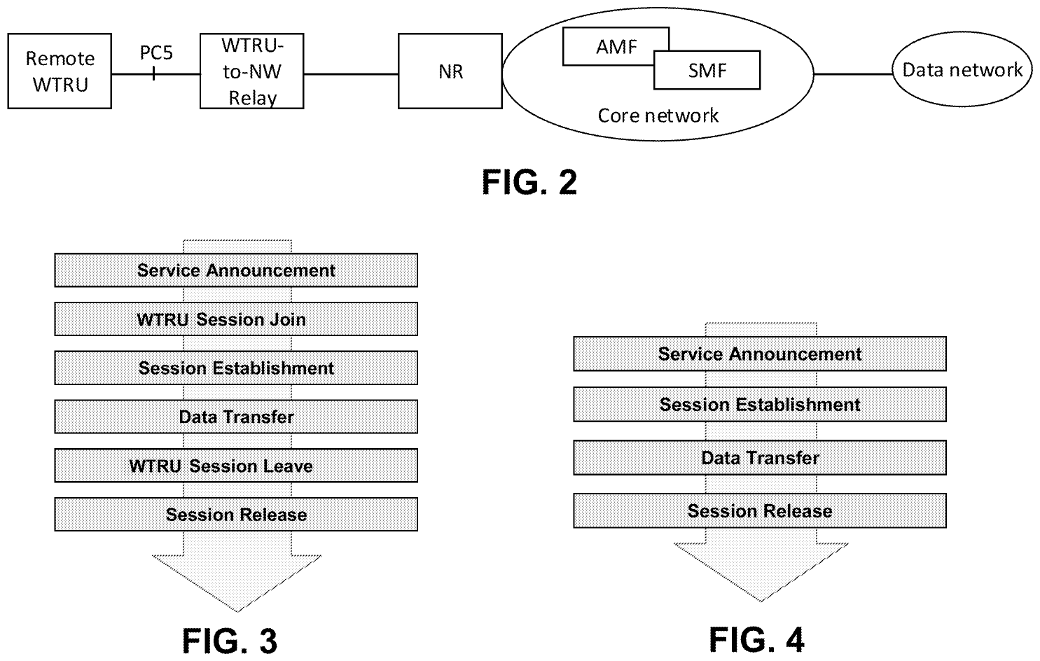

A proximity services (ProSe) WTRU-to-network relay may be implemented. Proximity services may be provided (e.g., by a 3GPP system) which may be based on WTRUs being in proximity to each other. A ProSe WTRU-to-network relay entity may provide functionality to support connectivity to the network for remote WTRUs (e.g., as shown in FIG. 2).

FIG. 2 illustrates an example architecture of a ProSe WTRU-to-network relay. In examples, a remote WTRU may discover and select a WTRU-to-network relay if the remote WTRU is out of network (e.g., new radio (NR)) coverage) and may be unable to communicate with a core network (CN) directly. In examples, a remote WTRU may discover and/or select a WTRU-to-network relay if the remote WTRU is in NR coverage but is configured to use PC5 for communication. In examples (e.g., for a layer 3 (L3) relay scenario), a remote WTRU may establish a PC5 session with a WTRU-to-network. The WTRU-to-network relay may establish a PDU session (or a PDN connection in the evolved packet core (EPC)) for the remote WTRU. A remote WTRU may connect to an L3 WTRU to Network Relay (U2NW) relay (e.g., using a PC5 link), which may provide network connectivity to the remote WTRU by establishing a PDU session or by reusing/modifying an existing PDU session (e.g., over the Uu link).

A ProSe L2 relay may be implemented. A remote WTRU may be visible to the network. A RAN may terminate radio resource control (RRC) signaling and next generation application protocol (NG-AP) signaling. The behavior of the remote WTRU may be interpreted similar to (e.g., the same as) regular WTRU behavior (e.g., from an AMF point of view). The behavior of the remote WTRU may access a 5G-RAN via a ProSe L2 relay. The RRC layer behavior may be interpreted similar to (e.g., the same as) regular WTRU behavior (e.g., from a 5G-RAN point of view). The ProSe L2 Relay WTRU AMF may be different from the AMF of the remote WTRU.

MBS may be implemented in a (e.g., 5G) network. Architectural enhancements may (e.g., to a 5G system) support multicast and broadcast communication services. Multicast data transmission may be enabled by a procedure shown in FIG. 3.

FIG. 3 illustrates an example of a high level flow diagram for a WTRU to receive multicast traffic (e.g., in 5GS). One or more of the following processes or phases may be performed for a (e.g., specific) WTRU: a WTRU session join; or a WTRU session leave. A WTRU session join may be a process by which a WTRU may (e.g., may attempt to) join an MBS session. In examples, a WTRU may indicate to a network (e.g., 5G core (5GC)) a request to receive multicast data (e.g., identified by a specific MBS session ID). A WTRU session leave may be a process by which a WTRU may leave an MBS session. In examples, a WTRU may indicate a request to no longer receive multicast data (e.g., identified by a specific MBS session ID).

One or more of the following phases may be performed for a (e.g., specific) service: service announcement (SA), session establishment, data transfer, or session release.

A SA may be used to distribute at least one of the following: information about the service; parameters for service activation; or other service related parameters (e.g., service start time). An MBS SA may be delivered to WTRUs in the target service area on an application level. The MBS SA may be delivered by an AF or an Multicast Broadcast Service Function (MBSF). An application level may include MBS service specific parameters. The MBS service specific parameters may include at least a DNN, an MBS service session ID, a target service WTRU group ID, an IP multicast address, a TMGI, etc. A SA may be provided (e.g., by an AF and/or a content provider) over application level signaling. A SA procedure may be triggered by a WTRU (e.g., by sending an NAS message to the AMF).

Session establishment may be the point at which transmission resources may be established for transmitting downlink (DL) multicast data between 5GC and NG-RAN. Session establishment may be triggered by a WTRU session join request from a WTRU. A data transfer may be a phase when multicast data is transferred to WTRUs. A session release may be a point at which there may not be a need to transmit multicast data (e.g., more multicast data). Resources in 5GS may be released based on (e.g., at or during) session release.

FIG. 4 illustrates an example of phases of broadcast data provisioning. FIG. 4 illustrates an example of a high level flow diagram for a WTRU to receive broadcast traffic in a network (e.g., a 5G system (5GS)).

One or more of the following phases may be performed for a (e.g., specific) service: service announcement (SA), session establishment, data transfer, or session release.

A SA may (e.g., may be used to) distribute at least one of: information about a service, parameters for service activation, or other service-related parameters (e.g., service start time). A SA procedure may be similar to (e.g., the same as) a procedure for a multicast transmission (e.g., a procedure as described herein).

Session establishment may be the point at which transmission resources may be established for transmitting DL Broadcast data between 5GC and NG-RAN. Session establishment may be triggered by a request from an AF.

Data transfer may be a phase when multicast data is transferred in an air interface.

A session release may be the point at which there may not be a need to transmit more broadcast data. Resources in 5GS may be released based on (e.g., at or during) session release.

A SA may be provided for a remote WTRU. A SA procedure (e.g., as described herein) may be used (e.g., by an MBS content provider or an AF) to inform users about one or multiple available multicast/broadcast (MB) services. One or more parameters to configure MBS at a WTRU may be included in one or more SAs. Configuration parameters may include one or more of: a DNN, an MBS service session ID, a target service WTRU group ID, an IP multicast address, a TMGI, target area information or the like. A relay WTRU (e.g., an L3 relay) may receive SA parameters by triggering a SA procedure. An SA procedure may be triggered, for example, via at least one of: an NAS message; or by user plane. A relay WTRU may provide (e.g., via an NAS message and/or by user plane) information about the service the relay WTRU may be interested in (e.g., by providing a USD to an AF). A relay WTRU may store a SA. The stored service parameters at the relay WTRU may not be relevant to a remote WTRU if the remote is interested in a different service. SA information corresponding to remote WTRU service info (e.g., a USD) may be provided to a remote WTRU for the remote WTRU to receive an associated MBS transmission. A procedure may enable, support, and/or be configured for reception of a SA and/or corresponding service parameters by a remote WTRU.

A remote WTRU may trigger and/or receive SA information from a content provider if the remote WTRU is connected via relay WTRU (e.g., L3 relay).

An MBS session may be established for a remote WTRU. A WTRU may join a multicast session by indicating (e.g., to 5GC, such as via an AMF or a session management function (SMF) that the WTRU requests to receive multicast data. The indication may identify a source of multicast data by providing an MBS Session ID. The WTRU may join a multicast group, by sending a PDU session modification request (e.g., with the MBS Session ID). An MBS Session ID may indicate the multicast group that the WTRU wants to join. A remote WTRU connected via a relay WTRU (e.g., an L3 relay WTRU) may not (e.g., be able to) perform signaling with the network if a PDU session is established between the relay WTRU and the network. A relay WTRU may establish the multicast session on behalf of the remote WTRU. The relay WTRU may (e.g., may then) send the multicast transmission to the remote WTRU. The relay WTRU may establish and send the multicast transmission to more than one remote WTRU via one or more PC5 broadcast/multicast mechanisms (e.g., alternatively and/or additionally).

A remote WTRU may join a session and start receiving MBS traffic if receiving (e.g., after receiving) a SA. A relay WTRU may join a session on behalf of one or multiple remote WTRU(s) (e.g., additionally and/or alternatively).

A SA procedure may be provided for a remote WTRU. In examples, a relay WTRU may receive a SA for one or more MB services (e.g., that the relay WTRU may be interested in). A relay WTRU may broadcast support for MBS (e.g., over PC5) based on at least one of: received SA information; or the capability of the relay WTRU. An MBS support indication may be broadcasted by a relay WTRU as part of a (e.g., PC5) discovery message. An MBS support indication may be included in a RSC broadcasted over a (e.g., PC5) discovery message. An MBS support indication may be an indication (e.g., an explicit indication) for the support of MBS in a PC5 discovery message. A relay WTRU may indicate support for MBS during a (e.g., PC5) unicast direct link establishment procedure (e.g., alternatively and/or additionally). An indication to support MBS and/or the service information (e.g., a USD) may be sent by a relay WTRU in a (e.g., PC5) direct link establishment accept message.

A remote WTRU may start an MBS SA procedure with a relay WTRU if the remote WTRU is triggered (e.g., by the remote WTRU's application layer) to receive an MBS transmission. An MBS SA procedure may be initiated based on the knowledge that the relay WTRU supports MBS. The remote WTRU may send the MBS SA request (e.g., an MBS SA Req) message (e.g., a PC5 message) to the relay WTRU (e.g., over PC5). The MBS SA request (e.g., MBS SA Req) message (e.g., PC5 message) may include at least one of: the remote WTRU ID (e.g., a subscription permanent identifier (SUPI), ProSe ID, L2 ID, IP address, FQDN, and/or the like); or information about the MB service (e.g., a USD) that the remote WTRU may be interested in.

A relay WTRU may determine whether the relay WTRU has (e.g., already has) the SA parameters corresponding to received service information (e.g., a USD) from the remote WTRU based on (e.g., upon) receiving the MBS SA request (e.g., MBS SA Req) message (e.g., PC5 message). The relay WTRU may send the MBS SA response (e.g., MBS SA Res) message (e.g., PC5 message) to the remote WTRU (e.g., with SA parameters) if the relay WTRU already has the SA information. The SA parameters may include one or more of: a DNN, an MBS service session ID, a target service WTRU group ID, an IP multicast address, a TMGI, MBS service area information, or the like. The relay WTRU may (e.g., alternatively and/or additionally) broadcast the SA.

The relay WTRU may send an NAS message to the network (e.g., an AMF) to trigger the network to send a SA corresponding the service information (e.g., a USD) received from the remote WTRU if the relay WTRU has not received or has not already stored SA parameters corresponding to received service information (e.g., a USD). The relay WTRU may include at least one of: the remote WTRU ID; or the service information (e.g., a USD) in the NAS message (e.g., to the 5GC). The AMF and/or other network nodes (e.g., MBSF or MB-SMF) may (e.g., may then) interact with an external content provider or the AF (e.g., via the network exposure function (NEF) to inform the content provider to configure/provide the SA parameters to the relay WTRU. The WTRU ID, which may be included in the request to the content provider server or the AF, may be the relay WTRU ID (e.g., GPSI, SUPI, IP address, ProSe ID, L2 ID) if (e.g., since) the SA is sent to the relay WTRU by the AF.

The relay WTRU may receive the SA information from the AF via user plane or application level signaling. The relay WTRU may store the received SA parameters corresponding to the service info (e.g., a USD) based on (e.g., upon) receiving the SA. In examples, the relay WTRU may (e.g., may then) send the service parameters to the remote WTRU by sending a (e.g., PC5) MBS SA response message (e.g., MBS SA Res), which may be unicast to a requesting remote WTRU. In examples, the relay WTRU may (e.g., may then) send the service parameters to the remote WTRU by sending a (e.g., PC5) MBS SA message, which may be broadcast. The parameters may include one or more of: a DNN, an MBS service session ID, a target service WTRU group ID, an IP multicast address, a TMGI, MBS service area information, or the like. The (e.g., PC5) message may be a unicast or a broadcast message. The relay WTRU may (e.g., may decide to) respond via a SA message (e.g., a SA broadcast message) if the relay WTRU received the SA request from multiple remote WTRUs for the same MBS service.

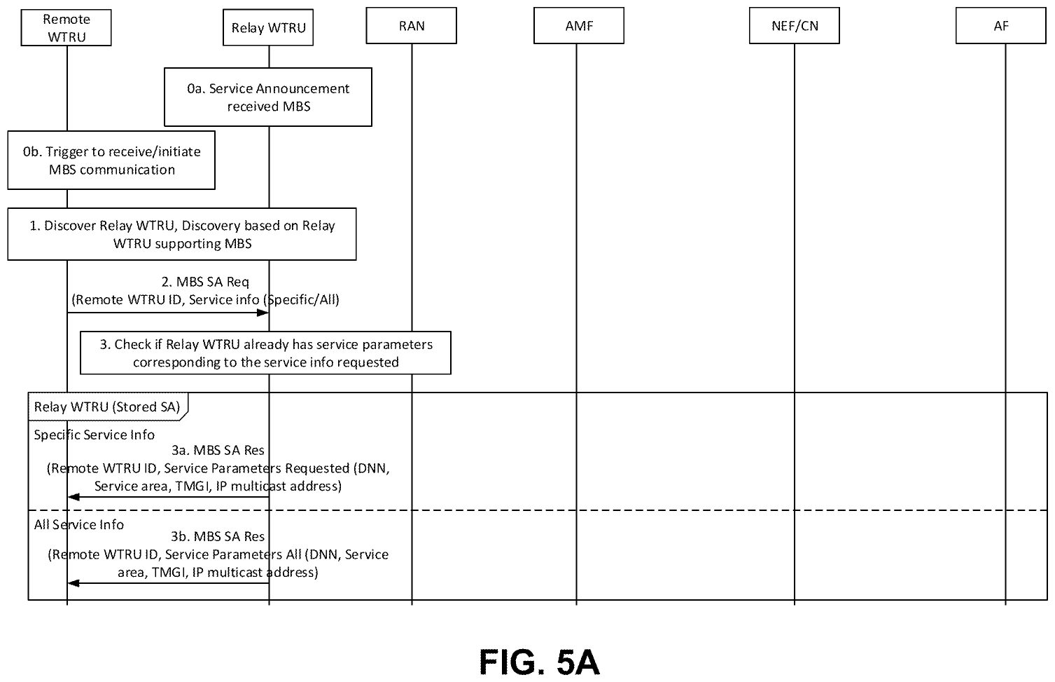

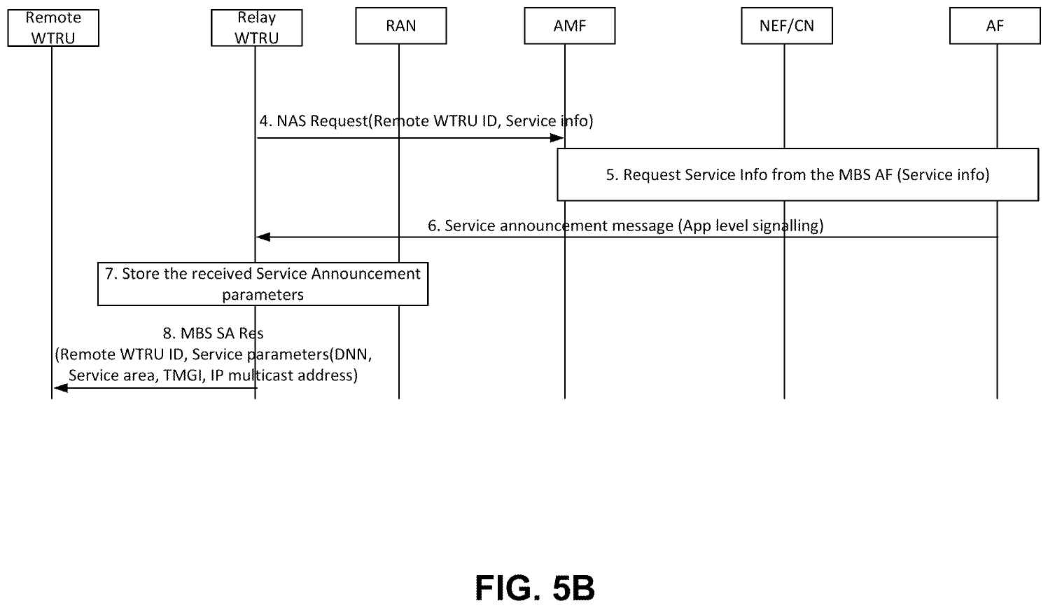

FIGS. 5A and 5B illustrate an example procedure for a remote WTRU to receive an MBS SA. As shown in FIG. 5A, at 0a, a relay WTRU may receive a SA from a content provider server or the AF (e.g., as per a procedure described herein). The relay WTRU may (e.g., thus be able to decide to) join the MB service based on the received SA. The relay WTRU may store the received SAs.

At Ob, the higher layers or the application layer in the remote WTRU may trigger the remote WTRU to receive a MBS transmission.

At 1, the remote WTRU may discover the relay WTRU that supports the MBS service. Discovery of the relay WTRU may occur through a discovery procedure where the relay WTRU broadcasts the capability to support MBS in a first message (e.g., (e.g., PC5) discovery message) to the remote WTRU. The relay WTRU may send the MBS support in the indication during a (e.g., PC5) direct link establishment procedure (e.g., alternatively and/or additionally). In examples (e.g., for the latter case), the support for at least one of: an MBS indication; or the MBS services supported (e.g., based on the operation at 0a) by the relay WTRU may be sent to the remote WTRU in the (e.g., PC5) direct link establishment accept message.

At 2, the remote WTRU may send a second message (e.g., the (e.g., PC5) message), which may be an MBS SA request (e.g., MBS SA Req), to the relay WTRU to request SA parameters. The remote WTRU may include at least one of: the remote WTRU ID (e.g., remote WTRU ProSe ID, IP address, SUPI, and/or the like); or service information (e.g., indicating a specific USD, ALL available, or other indication) in the second message (e.g., PC5 message).

At 3, the relay WTRU may determine one or more service parameters associated with the MBS service that are requested by the MBS SA request. In examples, the WTRU may determine whether (e.g., check if) the relay WTRU already has the stored SA parameters (e.g., associated with a previous request) corresponding to the service information requested from the remote WTRU (e.g., at 2). The relay WTRU may follow 3a or 3b (e.g., based on the requested information) if the relay WTRU has the stored SA parameters.

At 3a, the relay WTRU may send a broadcast or a unicast (e.g., PC5) message, such as an MBS SA response (e.g., MBS SA Res), to the remote WTRU. The (e.g., PC5) message may include the SA parameters requested by the remote WTRU.

At 3b, the relay WTRU may send a broadcast or a unicast (e.g., PC5) message, such as an MBS SA response (e.g., MBS SA Res), to the remote WTRU. The PC5 message may include (e.g., all) available SA parameters stored in the relay WTRU.

As shown in FIG. 5B, at 4, the relay WTRU may send a fourth message (e.g., an NAS message) to the network (e.g., AMF or SMF) if the relay WTRU doesn't have the corresponding SA parameters. For example, the relay WTRU may send a remote WTRU request message (e.g., with remote WTRU ID and/or the MBS service information, such as a USD) received from the remote WTRU. The relay WTRU may decide to not send a message to the network if a NAS message including the same service information has been sent earlier and the relay WTRU is waiting for the SA from the network.

At 5, the network may send a request to the content provider server or the AF based on the received NAS message and the service info. The AMF and/or other network nodes (e.g., SMF, MBSF, or MB-SMF) may send a request message to the external content provider or the AF (e.g., via the NEF) to trigger the content provider to configure or provide the SA parameters to the relay WTRU.

At 6, the content provider server or the AF may send a fifth message (e.g., a SA message (e.g., via application level signaling)) to the relay WTRU. The fifth message (e.g., the SA message) may indicate SA information. The SA information may be associated with the WTRU ID and/or the MBS service information. The SA information may indicate a content provider that is associated with the MBS service. The service parameters may be determined using the SA information. The service parameters (e.g., a DNN, an MBS service session ID, a target service WTRU group ID, an IP multicast address, a TMGI, MBS service area information, and/or the like) may be sent by the AF to the relay WTRU in the fifth message (e.g., SA message).

At 7, the relay WTRU may store the received SA and the parameters. The relay WTRU may (e.g., further) determine whether one or more WTRUs have requested the SA corresponding to the service information (e.g., a USD), which may be received at 2. The relay WTRU may (e.g., decide to) respond (e.g., via a broadcast message) if multiple remote WTRUs requested the SA for the same service information (e.g., a USD).

At 8, the relay WTRU may send a third message (e.g., broadcast or a unicast (e.g., PC5) message (e.g., an MBS SA response) to the remote WTRU. The third message (e.g., PC5 message) may indicate (e.g., may include) the SA parameters received by the relay WTRU (e.g., at 6).

The remote WTRU may (e.g., decide to) join the MBS session if the SA is received at the remote WTRU. The remote WTRU may (e.g., decide to) join the MBS session by sending an (e.g., a PC5) MBS join request message to the relay WTRU. The message may include the MBS session ID. The relay WTRU may send a WTRU session join to the network if the relay WTRU has not already joined the MBS session.

The remote WTRU may send an (e.g., a PC5) MBS leave request message to the relay WTRU if the remote WTRU desires to leave the MBS session. The relay WTRU may leave the MSB session if the service is not being used by a remote WTRU or the relay WTRU.

A remote WTRU MBS session may be established. An MBS session may be associated with an RSC. A remote WTRU and a relay WTRU may be provisioned or configured with an association between the RSC and the MBS session ID (e.g., a TMGI). The remote WTRU may retrieve the corresponding RSC for the PDU session ID and/or may discover the relay WTRU that supports the RSC if the application layer in the remote WTRU triggers the remote WTRU to receive MBS traffic for a (e.g., specific) PDU session ID. The remote WTRU may (e.g., may then) establish a (e.g., PC5) connection with the relay WTRU for the RSC. The relay WTRU may join the MBS session (e.g., based on the association between the RSC and the MBS session ID) and/or may deliver received MBS traffic to the remote WTRU.

The relay WTRU may (e.g., before joining the MBS group or receiving MBS transmission) request that the remote WTRU broadcast the MBS service ID (e.g., a TMGI) that the relay WTRU receives from the RAN. The remote WTRU may send a (e.g., PC5) message (e.g., a TMGI request) to the relay WTRU. The relay WTRU may (e.g., may then) receive the broadcasted TMGIs from the RAN. The relay WTRU may send the TMGIs to the remote WTRU in a (e.g., PC5) response message (e.g., a TMGI announcement). The response message (e.g., TMGI announcement) may be a unicast or a broadcast (e.g., PC5) message. The response message (e.g., TMGI announcement) may include one or more TMGIs received by the relay WTRU. The response message may include an indication of whether the corresponding TMGI is either for multicast or broadcast transmission. The relay WTRU may (e.g., may continue to) broadcast the response message as long as there is one or more remote WTRUs receiving the MBS transmission.

The remote WTRU (e.g., before performing the TMGI request procedure) may determine whether the MBS Service ID (e.g., a TMGI) that the remote WTRU may be interested in is already being broadcasted by the relay WTRU. The remote WTRU may not perform the response message (e.g., TMGI announcement) procedure if the corresponding TMGI is already being broadcasted by the relay WTRU.

The remote WTRU may already have a (e.g., PC5) connection established with the selected relay WTRU (e.g., alternatively and/or additionally). The remote WTRU may (e.g., if the remote WTRU already has a connection with the relay WTRU) send a (e.g., PC5) link modification request with the RSC, which may be included in the message. The relay WTRU receiving the link modification request may (e.g., may then) behave as described herein (e.g., at 6 and beyond, such as trigger the join request, etc.).

The relay WTRU may send a (e.g., PC5) link modification accept message to the remote WTRU (e.g., alternatively and/or additionally, as shown in FIG. 5B at 8). The link modification accept message may indicate the MBS session is activated.

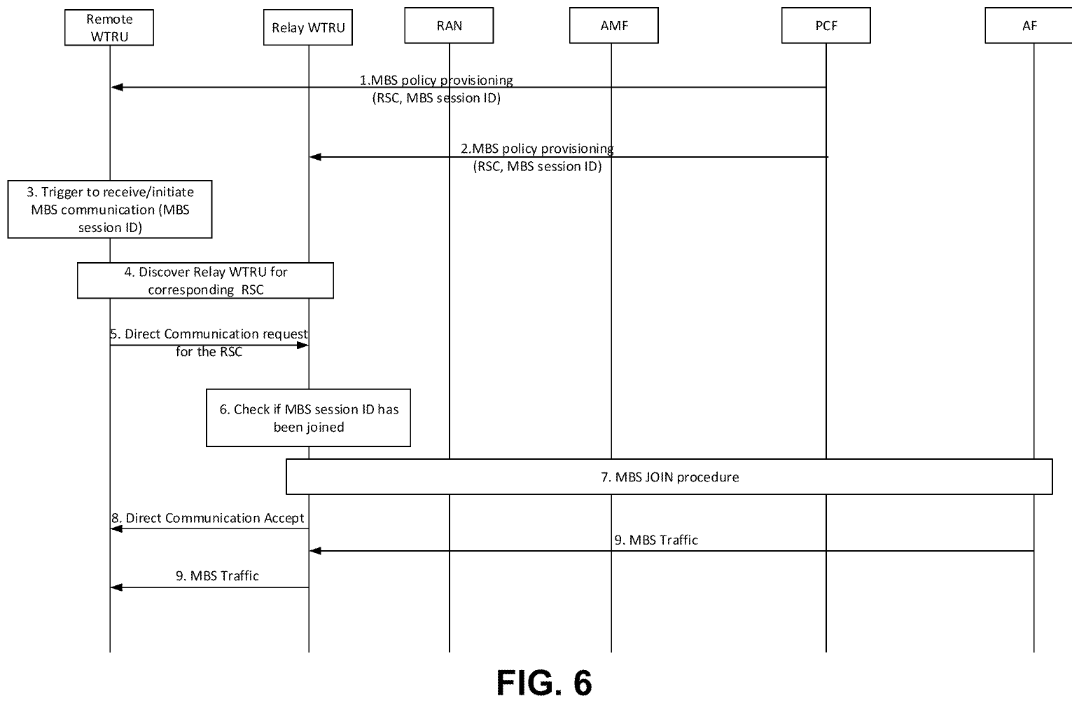

FIG. 6 illustrates an example procedure for a remote WTRU to receive an MBS service that may be associated with an RSC. As shown in FIG. 6, at 1, a policy control function (PCF) may (e.g., during a policy provisioning procedure) provide to the remote WTRU an association between an RSC and an MBS session ID.

At 2, the PCF may (e.g., during the policy provisioning procedure) provide to the relay WTRU the association between the RSC and the MBS session ID.

At 3, the remote WTRU may receive a trigger (e.g., from the application layer) for MBS traffic of a (e.g., specific) MBS session ID.

At 4, the remote WTRU may retrieve the corresponding RSC for the MBS session ID. The remote WTRU may perform a relay WTRU discovery procedure to discover the relay WTRU supporting the RSC. The remote WTRU may (e.g., during the WTRU discovery procedure) obtain the relay WTRU's L2 ID related to the RSC.

At 5, the remote WTRU may send a direct communication request to the relay WTRU. The request may indicate to establish a connection for the RSC. The request may include the relay WTRU's L2 ID or RSC, MBS Service ID (e.g., a TMGI), etc.

At 6, the relay WTRU may determine whether the relay WTRU has joined the MBS session (e.g., identified by the MBS session ID). The relay WTRU may trigger an MBS join procedure to join the MBS session if the relay WTRU has not joined the MBS session.

At 7, the relay WTRU may join the MBS session. The relay WTRU may associate the MBS session with the remote WTRU. In examples, the association may create a mapping of the MBS session ID with the L2/IP address of the one or more remote WTRUs that join the MBS session.

At 8, the relay WTRU may send a communication accept message (e.g., a direct communication accept message) to the remote WTRU. The direct communication accept message may indicate that the MBS session is activated. The direct communication accept message may include the L2 group ID to receive multicast transmission.

At 9, the relay WTRU may forward the MBS traffic to the remote WTRU. The remote WTRU may receive the multicast transmission. Unicast transmission may be used between the relay and remote WTRU(s). In examples, the relay WTRU may send the MBS traffic to the one or more remote WTRU(s) associated with the MBS session ID over one or more respective unicast links (e.g., according to the association/mapping).

The remote WTRU may (e.g., may decide to) leave the MBS session by sending a leave request (e.g., an explicit leave request) in a (e.g., PC5) message (e.g., a link modification request) or by releasing the (e.g., PC5) link with the relay WTRU. The relay WTRU may remove the remote WTRU information from the mapping MBS session/remote WTRU(s) (e.g., as described herein) if the relay WTRU detects that a remote WTRU is leaving or has left the MBS session. The relay WTRU may initiate a WTRU session leave procedure with the network/AF if remote WTRUs (e.g., all remote WTRUs) have left the MBS session.

An MBS session may be associated with a destination L2 ID for reception. A remote WTRU and relay WTRU may be provisioned or configured with an association between the destination L2 ID for MBS and the MBS session ID. The remote WTRU may retrieve the destination L2 ID for MBS if the application layer in the remote WTRU triggers the remote WTRU to receive MBS traffic of a (e.g., specific) PDU session ID. The remote WTRU may (e.g., may then) monitor the destination L2 ID for MBS (e.g., to receive the MBS traffic).

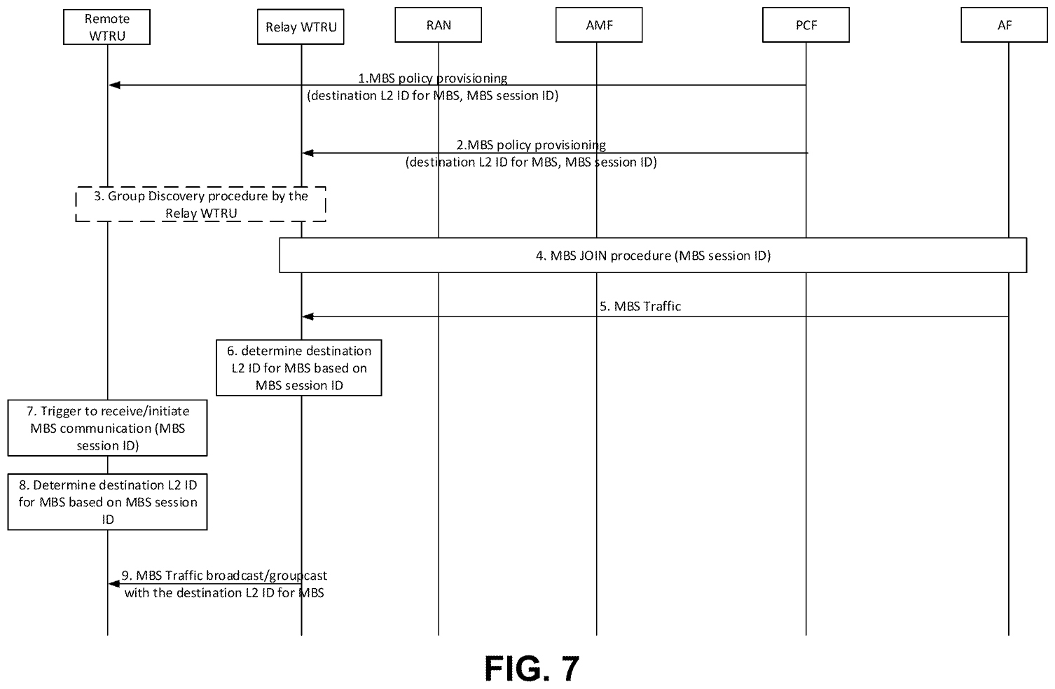

FIG. 7 illustrates an example procedure for a remote WTRU to receive an MBS service that may be associated with an L2 ID. As shown in FIG. 7, at 1, a PCF may (e.g., during a policy provisioning procedure) provide to a remote WTRU an association between a destination L2 ID for an MBS and an MBS session ID.

At 2, the PCF may (e.g., during the policy provisioning procedure) provide to the relay WTRU the association between the destination L2 ID for the MBS and the MBS session ID.

At 3, the relay WTRU may trigger a group discovery procedure to determine whether there is a remote WTRU interested in the MBS session ID.

At 4, the relay WTRU may join the MBS session (e.g., based on the MBS session ID).

At 5, the relay WTRU may receive MBS traffic from the network.

At 6, the relay WTRU may determine a destination L2 ID for MBS (e.g., based on the associations received at 2) before broadcasting/groupcasting the MBS traffic (e.g., in a PC5 interface).

At 7, the remote WTRU may receive a trigger (e.g., from the application layer) for MBS traffic of a (e.g., specific) MBS session ID.

At 8, the remote WTRU may determine a destination L2 ID for MBS (e.g., based on the associations received at 1). The remote WTRU may (e.g., may then) monitor the traffic based on the destination L2 ID for MBS.

At 9, the relay WTRU may send the MBS traffic with a destination L2 ID for MBS.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A relay wireless transmit/receive unit (WTRU), comprising:
a processor configured to:
send a first message, wherein the first message indicates that the relay WTRU supports a multicast-broadcast service (MBS);
receive a second message from a remote WTRU via a link, wherein the second message indicates an MBS service announcement (SA) request, a remote WTRU identity (ID), and a description of an MBS service;
determine one or more service parameters that are requested by the MBS SA request, wherein the one or more service parameters are associated with the MBS service; and
send a third message to the remote WTRU via the link, wherein the third message indicates the one or more service parameters.

17. The relay WTRU of claim 16, wherein for determining the one or more service parameters that are requested by the MBS SA request, the processor is further configured to:
send a fourth message to a network, wherein the fourth message indicates the remote WTRU ID and the description of the MBS service;
receive a fifth message from the network, wherein the fifth message indicates SA information, wherein the SA information is associated with the remote WTRU ID and with the description of the MBS service, and wherein the SA information indicates a content provider that is associated with the MBS service; and
determine the one or more service parameters using the SA information.

18. The relay WTRU of claim 17, wherein the fifth message is a SA message.

19. The relay WTRU of claim 16, wherein the one or more service parameters associated with the MBS service comprise at least one of: a data network name (DNN), an MBS service session ID, a target service WTRU group ID, an internet protocol (IP) multicast address, or a temporary mobile group identity (TMGI).

20. The relay WTRU of claim 16, wherein the third message further indicates an MBS SA response.

21. The relay WTRU of claim 16, wherein the processor is configured to determine the one or more service parameters that are requested by the MBS SA request by determining the one or more service parameters using SA information associated with a previous request.

22. The relay WTRU of claim 16, wherein the link is a PC5 unicast link.

23. A method performed by a relay wireless transmit/receive unit (WTRU), comprising:
sending a first message, wherein the first message indicates that the relay WTRU supports a multicast-broadcast service (MBS);
receiving a second message from a remote WTRU via a link, wherein the second message indicates an MBS service announcement (SA) request, a remote WTRU identity (ID), and a description of an MBS service;
determining one or more service parameters that are requested by the MBS SA request, wherein the one or more service parameters are associated with the MBS service; and
sending a third message to the remote WTRU via the link, wherein the third message indicates the one or more service parameters.

24. The method of claim 23, wherein the fifth message is a SA message.

25. The method of claim 23, wherein for determining the one or more service parameters that are requested by the MBS SA request, the method further comprises:
sending a fourth message to a network, wherein the fourth message indicates the remote WTRU ID and the description of the MBS service;
receiving a fifth message from the network, wherein the fifth message indicates SA information, wherein the SA information is associated with the remote WTRU ID and with the description of the MBS service, and wherein the SA information indicates a content provider that is associated with the MBS service; and
determining the one or more service parameters using the SA information.

26. The method of claim 23, wherein the one or more service parameters associated with the MBS service comprise at least one of: a data network name (DNN), an MBS service session ID, a target service WTRU group ID, an internet protocol (IP) multicast address, or a temporary mobile group identity (TMGI).

27. The method of claim 23, wherein the third message further indicates an MBS SA response.

28. The method of claim 23, further comprising determining the one or more service parameters that are requested by the MBS SA request by determining the one or more service parameters using SA information associated with a previous request.

29. The method of claim 23, wherein the link is a PC5 unicast link.

30. A remote wireless transmit/receive unit (WTRU), comprising:
a processor configured to:
receive a first message, wherein the first message indicates that a relay WTRU supports a multicast-broadcast service (MBS);
send a second message to the relay WTRU via a link, wherein the second message indicates a remote WTRU ID and a description of an MBS service to be provided by a network; and
receive a third message from the relay WTRU via the link, wherein the third message indicates one or more service parameters associated with the MBS service.

31. The remote WTRU of claim 30, wherein the one or more service parameters associated with the MBS service comprise at least one of: a data network name (DNN), an MBS service session ID, a target service WTRU group ID, an internet protocol (IP) multicast address, or a temporary mobile group identity (TMGI).

32. The remote WTRU of claim 30, wherein the second message further indicates an MBS SA request.

33. The remote WTRU of claim 30, wherein the third message further indicates an MBS SA response.

34. The remote WTRU of claim 30, wherein the link is a PC5 unicast link.
